(19) United States
(12) Patent Application Publication
(10) Pub. No.: US 2009/0233506 A1
(43) Pub. Date: Sep. 17, 2009

(54) Bladder of inflatable floating-assistant vest and manufacturing method of the same

(76) Inventor: Wei-Liang Lee, Taipei City (TW)

Correspondence Address: The Weintraub Group, P.L.C., 28580 Orchard Lake Road, Suite 140, Farmington Hills, MI, 48334, US

(21) Appl. No.: 12/076,258

(22) Filed: Mar. 14, 2008

(51) Int. Cl. B63C 9/11; B23P 17/04

(52) U.S. Cl. 441/106; 29/428

(57) ABSTRACT

The present invention relates to a bladder of floating-assistant vest in which a chest bladder and a back bladder are provided and fit with the ergonomic of human being's shoulder; the waterproof fabric blanks are tailored so a W-shaped sheet member composed by the two tailored waterproof fabric blanks is formed, the top end of the concave collar located at the center of the sheet member is provided with a rear sheet, the two ends of the rear sheet are respectively provided with a front sheet that downwardly and tiltingly extends, and a connecting sheet is upwardly and tiltingly extended from each bottom end of the front sheets, then the edge of the W-shaped sheet members is sealed so a hollow bladder member is formed; the shoulder portions of the two ends of the collar are tilted with an angle by the two front sheets closing to each other. When the bladder is desired to be fabricated to an inflatable floating-assistant vest, the rear sheet and the two front sheets are connected with a direct or an indirect fashion, and an open/close device is connected to the inner ends of the two front sheets of the bladder so as to achieve: (a) when the two front sheets are buckled, a shoulder shape that fit the ergonomic of human being's shoulder is formed on the shoulder portion; and (b) the inflatable float-assistant vest has a chest bladder and a back bladder communicating with each other.

### BACKGROUND OF THE INVENTION

1. Field of the Invention

The present invention relates to a bladder of inflatable floating-assistant vest, more particularly to a bladder of inflatable floating-assistant vest whose shoulder portions are made to be mated to shoulder shapes of a human beings, and further provide a manufacturing method of the bladder of inflatable floating-assistant vest.

2. Description of Related Art

An inflatable floating-assistant vest is mostly used for life rescue, e.g. a life jacket adopted in an air plane or a boat; when a passenger falls into water, the life jacket can be inflated so as to generate buoyancy, so the passenger can float in the water with the life jacket and wait for rescue. Based on the consideration of passenger's safety, the life jacket is without a doubt just for an emergency that no one wants to encounter.

With the trend of in-water and on-water activities become popular, the inflatable floating-assistant vest is mostly known as a snorkeling vest, the air inflated in the snorkeling vest is served to let a person float on the water. The development of the inflatable floating-assistant vest can be categorized in three major technical disclosures described below:

The first one is a conventional snorkeling vest. Take the snorkeling vest provided by the U.S. Pat. No. 4,035,857 as an example, the feature of such snorkeling vest is that the bladder is fabricated by tailoring two pieces of fabric blanks at one single time and welding at one single time; the disadvantage thereof is when the snorkeling vest is inflated and used, the shoulder portion of the snorkeling vest is fixed and not flexible and rather formed in a straight-line shape, so the shoulder portion thereof can not be mated to a shoulder portion of a human being, this will result in discomfort when wearing and further effecting on-water activities.

The second one is a collar-type snorkeling vest. Take the snorkeling vest disclosed in the U.S. Pat. No. 3,761,982 as an example, the appearance thereof has improved a lot comparing to the snorkeling vest mentioned above, but the disadvantage thereof is after the collar-type snorkeling vest is inflated, the shoulder portion thereof is still not flexible but formed in a straight-line shape which is not ergonomic and will result in discomfort when wearing and effect on-water activities.

The third one is a jacket-type snorkeling vest. Take the snorkeling vest disclosed in the U.S. Pat. No. 4,097,947 as an example. Comparing to conventional snorkeling vests the snorkeling vest disclosed herein has improved a lot: a bladder is provided in front of a jacket, the feature of the jacket-type snorkeling vest is that the appearance thereof is more pleasant looking and the wearing fashion thereof is the same as wearing an ordinary jacket, but the disadvantage of the snorkeling vest is two shoulder portions of the snorkeling vest are in straight-line shape and can not be bended with an angle, thus a seam is formed between the snorkeling vest and a tilted shoulder portion of a human being; and when the bladder is inflated, the bladder is only disposed in front of the jacket and can not be bended and extended to the back portion of the wearer.

With descriptions of the above mentioned snorkeling vests, it is known that the shoulder portions of the snorkeling vests are not mated to the shoulder portions of a human being that have tilting angles, so they do not meet the ergonomic requirements; so when wearing, the snorkeling vest will cause discomfort and the bladder thereof can not be extended to the back portion of the wearer.

### SUMMARY OF THE INVENTION

The applicant has devoted himself to design and commercially distribute diving related tools, with a wish to overcome the problem that a shoulder portion of a bladder of a conventional floating-assistant vest can not be mated to a shoulder portion of a human being that has a tilting angle and the bladder can be not bended and extended to the back portion of the wearer, after time and efforts, a bladder of a floating-assistant vest that can mate to a tilting angle of a human being's shoulder is developed, the present invention “Bladder of inflatable floating-assistant vest and manufacturing method of the same” is therefore provided.

In order to achieve the objects mentioned above, the present invention provides a bladder of a floating-assistant vest, two stacked waterproof fabric blanks are tailored so a W-shaped sheet member composed by the two tailored waterproof fabric blanks is formed, the top end of the concave collar located at the center of the sheet member is provided with a rear sheet, the two ends of the rear sheet are respectively provided with a front sheet that downwardly and tiltingly extends, and a connecting sheet is upwardly and tiltingly extended from each bottom end of the front sheets, then the edge of the W-shaped sheet member is sealed so a hollow bladder member is formed; the shoulder portions of two ends of the collar are tilted with a certain angle by the two front sheets closing to each other.

Another object of the present invention is to provide a bladder of floating-assistant vest and manufacturing method of the same, comprises the steps of: (a) two stacked waterproof fabric blanks are tailored so a W-shaped sheet member composed by the two tailored waterproof fabric blanks is formed, the top end of the concave collar located at the center of the sheet member is provided with a rear sheet, the two ends of the rear sheet are respectively provided with a front sheet that downwardly and tiltingly extends, and a connecting sheet is upwardly and tiltingly extended from each bottom end of the front sheets; (b) the edge of the W-shaped sheet member is sealed so a hollow bladder member is formed; the shoulder portions of the two ends of the collar are tilted with an angle by the two front sheets closing to each other.

### BRIEF DESCRIPTION OF THE DRAWINGS

FIG. 1 is a plan view of the waterproof fabric blank of the bladder provided with the present invention;

FIG. 2 is 3D exploded view of a floating-assistant vest formed by indirectly connecting to the bladder provided by the present invention;

FIG. 3 is a schematic view of a finished product of the floating-assistant vest formed by indirectly connecting to the bladder provided by the present invention;

FIG. 4 is 3D exploded view of a floating-assistant vest formed by directly connecting to the bladder provided by the present invention;

FIG. 5 is a schematic view of a finished product of the floating-assistant vest formed by directly connecting to the bladder provided by the present invention;

FIG. 6 is a schematic view of a finished product of the floating-assistant vest worn on the human body.

### DETAILED DESCRIPTION OF THE PREFERRED EMBODIMENTS

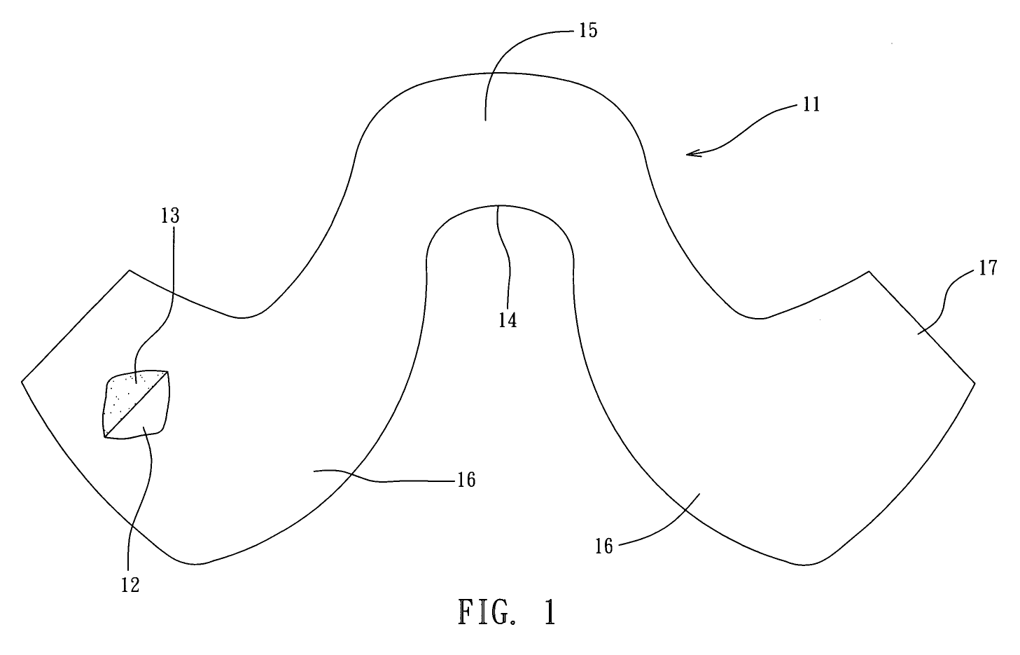

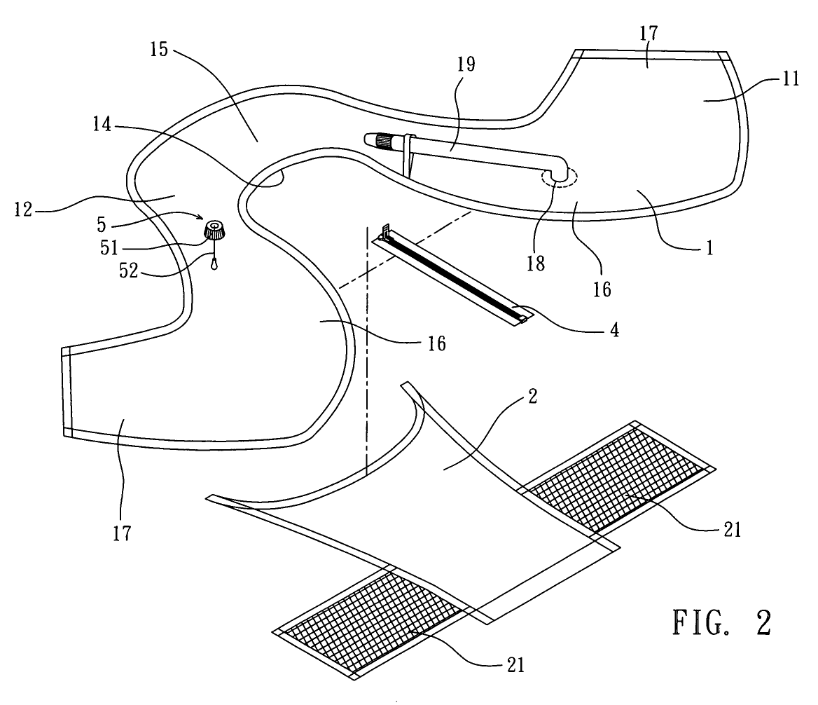

As shown in FIG. 1 and FIG. 2, the bladder 1 of floating-assistant vest provided by the present invention is made by tailoring two stacked waterproof fabric blanks 11 then a W-shapend sheet member composed by the two tailored waterproof fabric blanks, as shown in FIG. 1, is provided, then the edges of the two stacked waterproof fabric blanks 11 are sealed with a fashion, e.g. high-frequency weld, thermal pressing weld or gluing lamination, so a sealed hollow bladder member is formed. The fabrication of the waterproof fabric blank 11 is that at least one surface of a cloth 12 is coated with a waterproof material 13, e.g. PU (Polyurethane), or at least one surface of the cloth 12 is laminated with a layer of the waterproof material 13, e.g. PU (Polyurethane). After tailoring, the center of the sealed waterproof fabric blank 11 has a concave collar 14, a rear sheet 15 is formed on top of the collar 14, the two ends of the rear sheet 15 are respectively provided with a front sheet 16 that downwardly and tiltingly extends, and a connecting sheet 17 is upwardly and tiltingly extended from each bottom end of the front sheets 16, so after the waterproof fabric blanks 11 are fabricated to a bladder member, the shape thereof is like the W-shaped bladder 1.

As shown from FIG. 2 to FIG. 4, in order to provide the bladder 1 with functions of inflating and deflating, a pipe hole 18 is provided at the chest position of the front waterproof fabric blank 11 for connecting to an inflating/deflating pipe 19, so the bladder 1 can be inflated by blowing air into the inflating/deflating pipe 19, then a buoyancy is obtained; on the other hand, if the bladder 1 is to be deflated, the operation is also via the inflating/deflating pipe 19, which is a conventional art so will not be further described herein.

A fast deflating valve 5 can be at chest position of the bladder 1, the fast deflating valve 5 is communicated with and connected to the bladder 1 via a valve member 51. If an operation of fast deflation is desired to be processed via the fast deflating valve 5, a releasing member 52, e.g. a pulling string, capable of elastically opening and closing and communicating with the valve member 51 is pulled so the valve member 51 is opened, and air inside the bladder 1 can be rapidly exhausted via the valve member 51, so the buoyancy of the bladder 1 can be rapidly adjusted.

If the bladder 1, before inflated, provided by the present invention is desired to be made to a jacket-type floating-assistant vest, the rear sheet 15 of the bladder 1 is connected to the two connecting sheets 17 with a direct or an indirect fashion so arm holes are formed for allowing a wearer's arms pass through, and an open/close device 4 is also provided so the jacket-type floating-assistant is obtained.

Referring to FIG. 2, what is shown in FIG. 2 is an indirect connecting fashion of a inflatable floating-assistant vest, an accessory 2 is firstly connected to the top ends of the rear sheet 15 and the connecting sheets 17 of the bladder 1, the accessory 2 can be a cloth, a net-shaped cloth, a fastening strip, or a combination thereof, wherein the accessory 2 is preferably to be an elastic cloth so the accessory 2 can fit on a back portion of a human being thus a proper elasticity is provided; the semi-finished product is backwardly folded from the top end of the collar 14, and two extending sections 21 provided at two lateral ends of the accessory 2 are connected to the edges of the connecting sheets 17 of the bladder 1; wherein the extending sections 21 can be a cloth, a net-shaped cloth, a fastening strip, or a combination thereof, and preferably to be a net-shaped cloth for fitting on various body frames of human begins; two arm holes are respectively formed by the two extending sections 21 and the bladder 1 on top of the extending sections 21 and the accessory 2 for allowing arms of a wearer pass through.

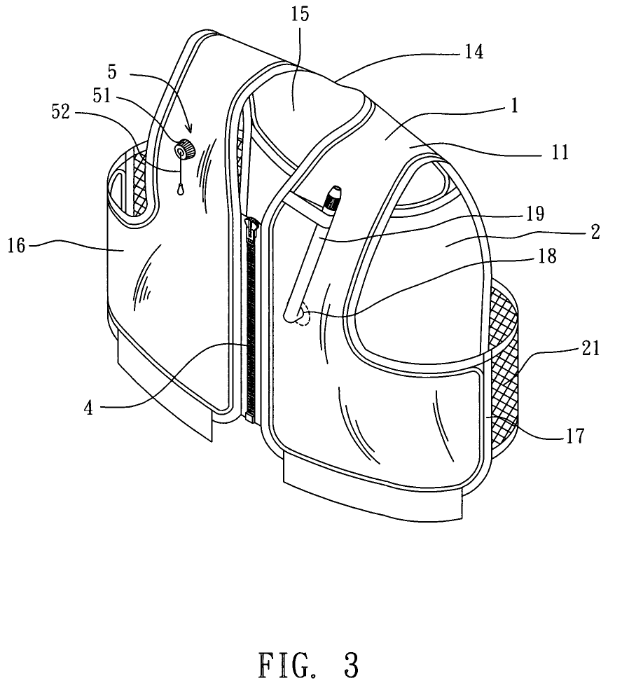

The inner ends of the two front sheets 16 of the bladder 1 are connected to the open/close device 4, e.g. a zipper provided with a sewing method, the open/close device 4 can also be, but not limited to, an inserting buckle or a fastening strip, then the jacket-type floating-assistant vest is obtained as shown in FIG. 3. Because of the unique tailoring method of the waterproof fabric blanks 11 provided by the present invention, in other words after the inner ends of the two front sheets 16, that are tiltingly and symmetrically provided toward the collar 14, are connected to the open/close device 4, two shoulder portions at two lateral ends of the collar 14 are therefore tilted with an angle that can mate to a tilting angle of a human being's shoulder portion, so when wearing the comfort for the wearer is increased.

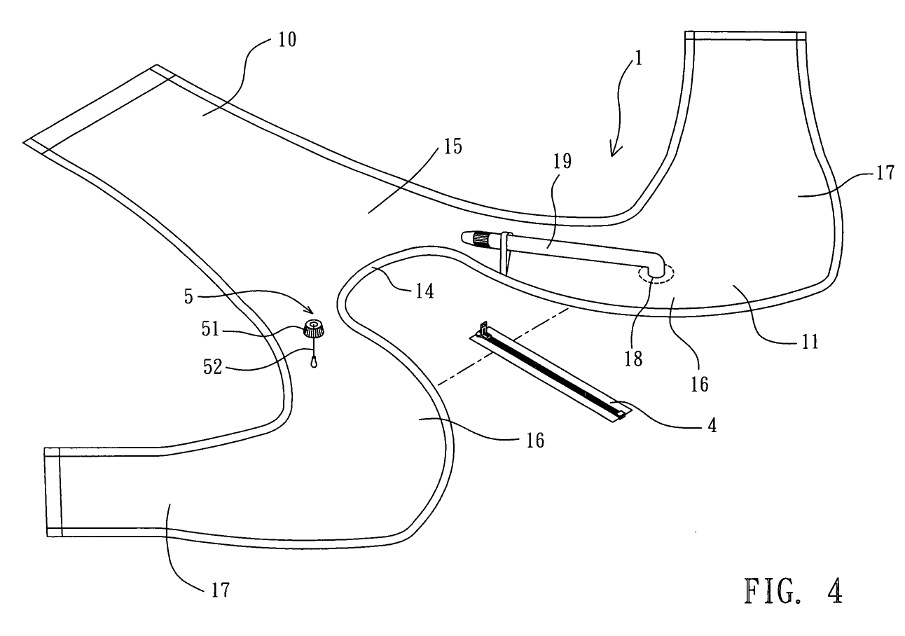

Referring to FIG. 4, what is shown in FIG. 4 is a direct connecting fashion of an inflatable floating-assistant vest for manufacturing a whole bladder structure without needs of providing any other component thereon, so the embodiment of the bladder-type floating-assistant vest is composed by the bladder 1 and the open/close device 4.

The difference between the bladder 1 herein and that in the other embodiments described above is that an extending sheet 10 is integrally extended from the rear sheet 15, and the edges of the two stacked waterproof fabric blanks 11 are sealed with a fashion, e.g. high-frequency weld, thermal pressing weld or gluing lamination, so a hollow bladder member is formed; then the semi-finished product is backwardly folded from the top end of the collar 14; and two ends of the extending sheet 10 are respectively connected to each free ends of the connecting sheets 17 with a fashion of a sew, a zipper, an inserting buckle, a cloth or a fastening strip, so an arm hole is formed by the connecting sheets 17 and the bladder 1 on top of the connecting sheets 17 and the extending sheet 10 for allowing an arm of the wearer passes through.

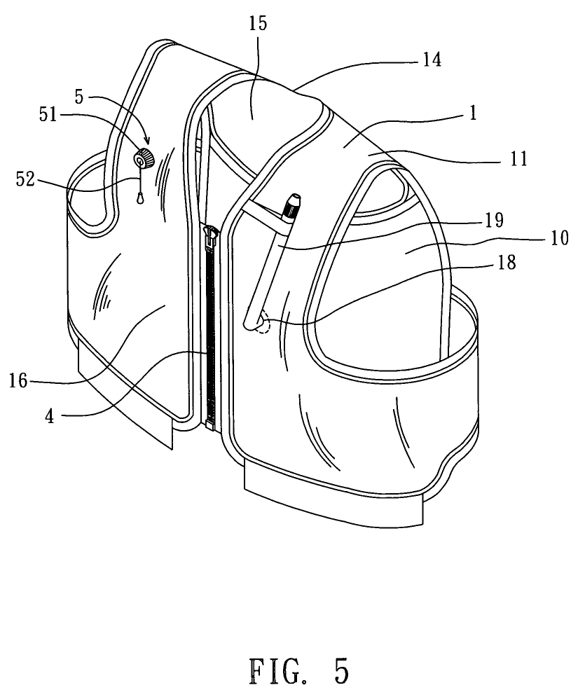

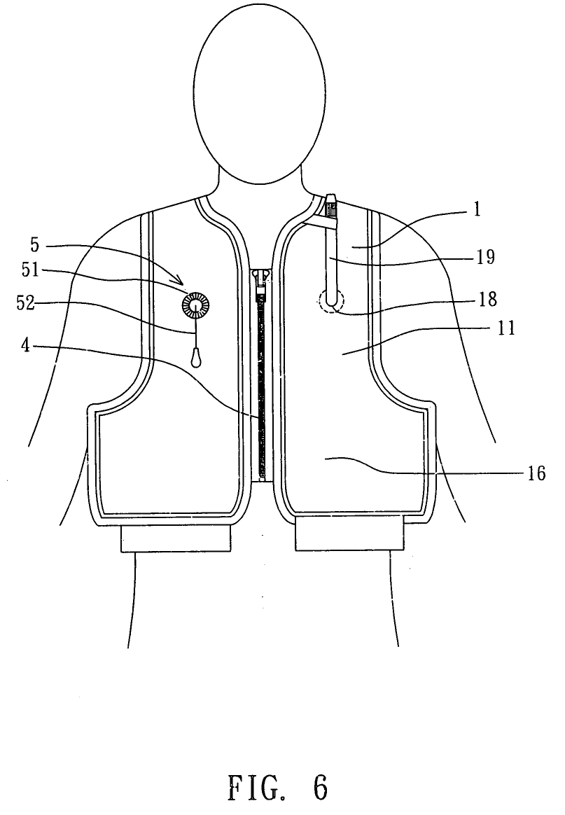

As shown in FIG. 5, what is shown in FIG. 5 is a schematic view of a finished product of the inflatable floating-assistant vest made with the direct connecting fashion; with the unique tailoring method of the waterproof fabric blanks 11 provided by the present invention, after the two inner ends of the two front sheets 16, that are tiltingly and symmetrically provided toward the collar 14, are connected to the open/close device 4, two shoulder portions at two lateral ends of the collar 14 are therefore tilted with an angle, as shown in FIG. 6, that can mate to a tilting angle of a human being's shoulder portion, so when wearing the comfort for the wearer is increased.

With the special design that the rear sheet and the front sheets respectively have a tilting angle; when the two front sheets close to each other, the shoulder portion of the bladder is formed with a tilting angle that mate to a tilting angle of a human being's shoulder portion and the rear sheet can also be bended and backwardly extended, so the comfort when wearing is increased. The manufacturing method provided by the present invention has lowered the production cost and shortened the manufacturing procedure, and the bladder of the floating-assistant vest provided by the present invention is formed by one-time tailoring and one-time edge sealing, so the operation is easy and convenient and the comfort for the wearer is increased.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bladder of inflatable floating-assistant vest, comprise:
two stacked waterproof fabric blanks, the waterproof fabric blanks are tailored so a W-shaped sheet member composed by the two tailored waterproof fabric blanks is formed, a top end of a concave collar located at the center of the sheet member is provided with a rear sheet, the two ends of the rear sheet are respectively provided with a front sheet that downwardly and tiltingly extends, and a connecting sheet is upwardly and tiltingly extended from each bottom end of the front sheets, then the edge of the periphery of the W-shaped sheet member is sealed so a hollow bladder member is formed; the shoulder portions of the two ends of the collar are respectively tilted with an angle by the two front sheets closing to each other and the top end of the rear sheet being backwardly folded.

2. The bladder of inflatable floating-assistant vest as claimed in claim 1, wherein the fabrication of the waterproof fabric blank is that at least one surface of a cloth is coated with a waterproof material, or at least one surface of the cloth is laminated with a layer of the waterproof material.

3. The bladder of inflatable floating-assistant vest as claimed in claim 2, wherein the waterproof material is PU (Polyurethane).

4. The bladder of inflatable floating-assistant vest as claimed in claim 1, wherein a pipe hole is provided at the chest position of the bladder for connecting to an inflating/deflating pipe.

5. The bladder of inflatable floating-assistant vest as claimed in claim 1, wherein a fast deflating valve is provided at a proper location of the bladder, the fast deflating valve is connected and communicated with the bladder via a valve member; the valve member has a releasing member capable of elastically opening and closing; so by operating the releasing member, air inside the bladder can be rapidly exhausted via the valve member.

6. The bladder of inflatable floating-assistant vest as claimed in claim 1, wherein the bladder is further provided with:
an accessory connected to the rear sheet of the bladder;
two extending sections extended from the two base ends of the accessory and respectively connected to the lateral ends of the connecting sheets and the rear sheet of the bladder so an arm hole is formed by each of the extending sections and the bladder on top of the extending sections and the rear sheet;
an open/close device connected to the inner ends of the two front sheets of the bladder.

7. The bladder of inflatable floating-assistant vest as claimed in claim 6, wherein the accessory and the extending sections are selected from a group consisting by a cloth, a net-shaped cloth, a fastening strip, or a combination thereof.

8. The bladder of inflatable floating-assistant vest as claimed in claim 6, wherein the open/close device is a zipper, an inserting buckle, or a fastening strip.

9. The bladder of inflatable floating-assistant vest as claimed in claim 1, wherein the bladder is further provided with:
an extending sheet integrally connected to the rear sheet, and the two connecting sheets are respectively connected to the lateral ends of the extending sheet disposed below the bladder, so an arm hole is formed by the two connecting sheets and the bladder on top of the connecting sheets and the extending sheet;
an open/close device connected to the inner ends of the two front sheets of the bladder.

10. The bladder of inflatable floating-assistant vest as claimed in claim 9, wherein the open/close device is a zipper, an inserting buckle, or a fastening strip.

11. A manufacturing method of bladder of inflatable floating-assistant vest, comprises the steps of:
(a) two stacked waterproof fabric blanks are tailored so a W-shaped sheet member is composed by the two tailored waterproof fabric blanks formed, a top end of a concave collar located at the center of the sheet member is provided with a rear sheet, the two ends of the rear sheet are respectively provided with a front sheet that downwardly and tiltingly extends, and a connecting sheet is upwardly and tiltingly extended from each bottom end of the front sheets;
(b) the edge of the W-shaped sheet members is sealed so a hollow bladder member is formed; the shoulder portions of the two ends of the collar are respectively tilted with an angle by the two front sheets closing to each other.

12. The manufacturing method of bladder of inflatable floating-assistant vest as claimed in claim 11, wherein the steps further comprise:
(c) when the rear sheet and the connecting sheets are connected with a direct or an indirect fashion, arm holes are formed between the rear sheet and the connecting sheets;
(d) an open/close device is connected to the inner ends of the two front sheets of the bladder.

13. The manufacturing method of bladder of inflatable floating-assistant vest as claimed in claim 12, wherein the indirect connecting fashion is that an accessory is connected to the rear sheet of the bladder, two extending sections are respectively extended from the two base ends of the accessory and are respectively connected to the lateral ends of the connecting sheets and the rear sheet of the bladder so an arm hole is formed by each of the extending sections and the bladder on top of the extending sections and the rear sheet.

14. The manufacturing method of bladder of inflatable floating-assistant vest as claimed in claim 12, wherein the direct connecting fashion is that an extending sheet is integrally extended from the rear sheet of the bladder, the two connecting sheets are respectively connected to the two ends of the extending sheet disposed below the bladder, so an arm hole is formed by the two connecting sheets and the bladder on top of the connecting sheets and the extending sheet.

15. The manufacturing method of bladder of inflatable floating-assistant vest as claimed in claim 12, wherein the open/close device is a zipper, an inserting buckle, or a fastening strip.

16. The manufacturing method of bladder of inflatable floating-assistant vest as claimed in claim 11, wherein the fabrication of the waterproof fabric blank is that at least one surface of a cloth is coated with a waterproof material, or at least one surface of the cloth is laminated with a layer of the waterproof material.

17. The manufacturing method of bladder of inflatable floating-assistant vest as claimed in claim 13, wherein the waterproof material is PU (Polyurethane).
